(19) United States
(12) Patent Application Publication
(10) Pub. No.: US 2026/0309125 A1
(43) Pub. Date: Oct. 8, 2026

(54) Wind Power Generation Device

(71) Applicants: Jan Duval Hansen, Edmonton (CN); Yunfei Jiao, Taiyuan (CN)

(72) Inventor: Yunfei Jiao, Taiyuan (CN)

(21) Appl. No.: 19/172,668

(22) Filed: Apr. 8, 2025

(51) Int. Cl. F03D 3/04; F03D 3/02; F03D 9/11; F03D 9/25

(52) U.S. Cl. CPC F03D 3/0427; F03D 3/02; F03D 9/11; F03D 9/25

(57) ABSTRACT

A wind power generation device is provided. The wind power generation device includes an outer cover installed below the interface platform, housing a plurality of generator sets equidistantly and circumferentially distributed, each generator set connected to power generation fan blades. A top cover is connected to the interface platform via fixing columns and includes a central light barrel made of heat-absorbing material to create low-pressure airflow zones. A wind guide plate with an inwardly concave wind guide arc surface directs airflow toward the fan blades to enhance rotation speed. A spiral blade, connected to a drive motor within the light barrel, generates swirling airflow to accelerate wind convergence and optimize power generation. The device integrates wind direction monitors and a controller to align the fan blades with surface wind directions in real time. This design maximizes resource utilization, enabling efficient energy generation even in low wind conditions.

### BACKGROUND OF THE INVENTION

The present invention relates to the technical field of wind turbines, specifically an array-type wind power generation device based on sunlight hearing and surface wind convergence.

Wind power generation systems have long been employed as a means of harnessing renewable energy from natural wind resources. These systems are widely utilized in various forms, ranging from large-scale wind farms to smaller residential wind turbines. The objective of such systems is to convert kinetic energy from wind into mechanical power, which is then used to generate electricity. Despite their widespread use and advancement, existing wind power generation devices exhibit significant limitations that hinder their efficiency and effectiveness.

Traditional wind turbines often feature single power generation structures that rely solely on naturally occurring wind patterns. This design limits their performance, as the distribution of wind is frequently scattered and irregular, resulting in inconsistent airflow and reduced rotation speeds of the turbine blades. Consequently, the power generation efficiency of these systems remains suboptimal, particularly in environments with low or inconsistent wind activity. Moreover, such systems typically fail to utilize additional natural resources, such as solar energy, to enhance their functionality.

Attempts have been made to improve the efficiency of wind turbines by incorporating alternative designs or supplemental features. For instance, some systems include adjustable blade angles or integrated storage mechanisms to better accommodate fluctuating wind conditions. While these modifications offer incremental improvements, they still fall short of addressing the fundamental challenges posed by irregular wind patterns. Furthermore, these systems are often complex and costly, requiring substantial maintenance and limiting their accessibility for widespread use.

Another significant drawback of existing wind power systems is their inability to operate effectively in the absence of sufficient wind. During periods of low wind activity, traditional turbines cease to function, leading to a waste of natural resources and an interruption in energy generation. These shortcomings have prompted the development of hybrid systems that integrate solar panels or other energy sources. However, such systems are typically separate from the wind turbine structure, resulting in inefficient resource utilization and increased installation complexity.

The limitations of current wind power generation devices underscore the need for an innovative solution that overcomes these deficiencies while maximizing the utilization of natural resources. Specifically, there is a need for a system that combines the advantages of wind power and solar energy to achieve consistent and efficient electricity generation. Such a system should address the scattered distribution of wind, improve blade rotation speeds, and enhance overall power generation efficiency, even in environments with low wind activity.

The present invention addresses these challenges by introducing a wind power generation device that integrates sunlight heating and surface wind convergence to optimize resource utilization. Unlike traditional systems, this device leverages a combination of airflow control mechanisms and solar heating to create consistent and directed airflow, thereby improving the rotation speed of the turbine blades and enhancing power generation efficiency. By incorporating innovative features such as spiral blades, low-pressure airflow zones, and real-time wind direction monitoring, the invention provides a practical and efficient solution to the longstanding challenges faced by conventional wind turbines.

In light of the devices disclosed in the known art, it is submitted that the present invention substantially diverges in design elements and methods from the known art and consequently it is clear that there is a need in the art for an improvement for a wind power generation device. In this regard the instant invention substantially fulfills these needs.

### SUMMARY OF THE INVENTION

In view of the foregoing disadvantages inherent in the known types of wind power generation devices now present in the known art, the present invention provides a new wind power generation device wherein the same can be utilized for maximizing resource utilization, enabling efficient energy generation even in low wind conditions.

It is an objective of the present invention to provide a wind power generation device that effectively integrates sunlight heating and surface wind convergence to maximize energy generation efficiency. The device includes an outer cover positioned below the interface platform, housing a plurality of generator sets equidistantly and circumferentially distributed. These generator sets are coupled to power generation fan blades, ensuring consistent power output even under irregular wind conditions. By incorporating sunlight heating through a light barrel and surface wind convergence, the device improves the rotation speed of the fan blades, overcoming limitations found in traditional wind power systems.

It is an objective of the present invention to provide a wind power generation device equipped with a light barrel comprising a heat-absorbing material to create low-pressure areas that enhance surface wind convergence. The heat-absorbing light barrel uses solar energy to induce rising airflow, creating a consistent and directed wind flow even during periods of low natural wind activity. This innovation ensures continuous energy generation by leveraging both natural wind and solar resources in a seamless and efficient manner.

It is an objective of the present invention to provide a wind power generation device incorporating a wind guide plate with an inwardly concave wind guide arc surface to optimize airflow direction. The wind guide plate directs surface wind through strategically positioned air vents and channels it toward the power generation fan blades. This design ensures maximum airflow utilization, increasing blade rotation speeds and improving the overall power generation efficiency.

It is an objective of the present invention to provide a wind power generation device that employs a spiral blade connected to a drive motor within the light barrel to create swirling airflow. The swirling airflow accelerates the flow of air from the bottom to the top of the light barrel, further enhancing wind convergence and driving the generator sets. This feature contributes to higher efficiency in power generation while minimizing energy loss in the airflow process.

It is an objective of the present invention to provide a wind power generation device equipped with wind direction monitors and a controller for real-time alignment of the power generation fan blades with surface wind directions. The wind direction monitors detect changes in wind patterns and communicate with the controller, which adjusts the orientation of the generator sets and fan blades accordingly. This automated alignment ensures optimal wind utilization, significantly improving energy output and operational reliability.

It is an objective of the present invention to provide a wind power generation device designed to generate electricity even in the absence of sunlight by utilizing natural surface wind at various angles. The circumferential arrangement of generator sets allows for efficient energy harvesting from winds coming from any direction. This capability ensures consistent energy production, reducing reliance on specific environmental conditions and avoiding the waste of natural resources.

It is therefore an object of the present invention to provide a new and improved wind power generation device that has all of the advantages of the known art and none of the disadvantages.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a perspective view of an embodiment of a wind power generation device.

FIG. 2 shows a side view of an embodiment of a wind power generation device.

FIG. 3 shows a top plan view of an embodiment of a wind power generation device.

FIG. 4 shows a cross-sectional view of an embodiment of a wind power generation device taken along line A-A of FIG. 3.

FIG. 5 shows a cross-sectional view illustrating the air flow direction of an embodiment of a wind power generation device.

### DETAILED DESCRIPTION OF THE INVENTION

Reference is made herein to the attached drawings. For the purposes of presenting a brief and clear description of the present invention, the preferred embodiment will be discussed as used for maximizing resource utilization, enabling efficient energy generation even in low wind conditions. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

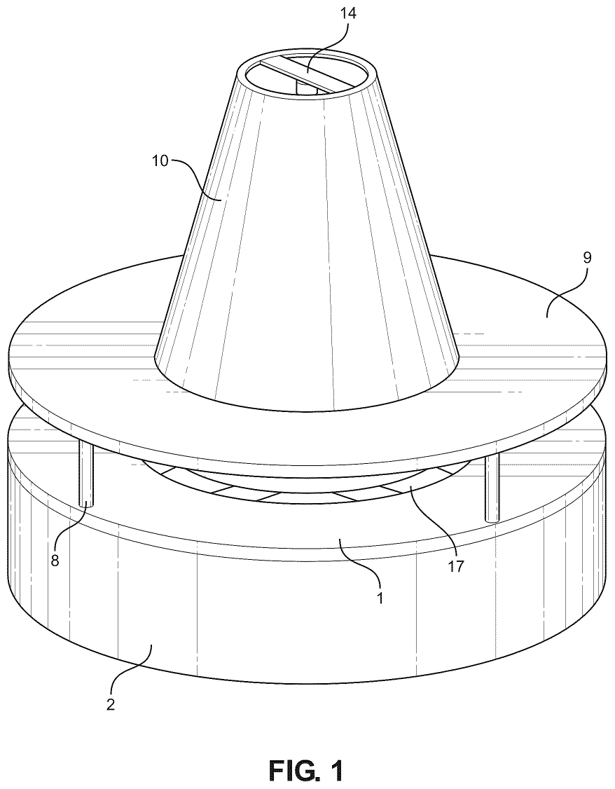

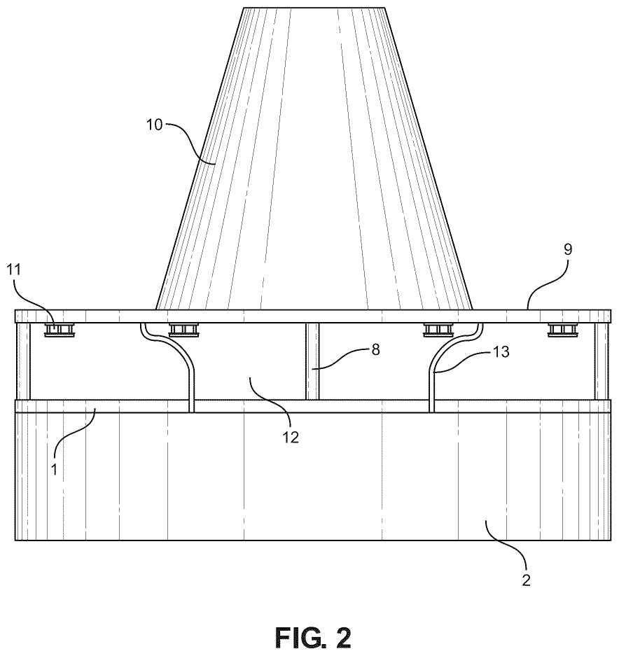

Referring now to FIGS. 1-3, there is shown a perspective view, a side view and a top plan view of an embodiment of a wind power generation device, respectively. The wind power generation device includes a housing having an outer cover 2 disposed below an interface platform 1 and a top cover 9 connected to the interface platform 1 via a plurality of fixing columns 8. The interface platform 1 serves as a reference point, with the outer cover 2 installed below it, housing the core components of the system. The outer cover 2 houses a plurality of generator sets 6 and power generation fan blades 7, which are distributed equidistantly and in a circumferential pattern for optimal airflow utilization. The power generation fan blades 7 are configured to rotate to generate electricity. The outer cover 2 is a durable, enclosed structure designed to protect the internal components from external environmental factors.

Above the interface platform, the top cover 9 is supported by multiple fixing columns 8, which are evenly spaced to ensure stability and maintain the alignment of the top cover 9. At the center of the top cover 9 is a light barrel 10. In the illustrated embodiment, the light barrel 10 comprises a conical structure made of heat-absorbing material designed to create a low-pressure zone and facilitate airflow acceleration. The light barrel comprises a larger diameter at the base that decreases toward the top. The light barrel is designed to accelerate airflow with the aid of a spiral blade, enhancing surface wind convergence and driving the power generation fan blades for consistent and efficient electricity production. Herein, surface wind convergence refers to the process in which surface-level airflows from multiple directions are directed and concentrated toward a specific location, increasing wind density and velocity in that area. In the context of the wind power generation device, surface wind convergence occurs when natural wind and induced airflow are guided and channeled through structural elements such as the wind guide plate 12, wind guide arc surface 13, and light barrel 10 to maximize the efficiency of the power generation fan blades 7. This process enhances wind utilization by ensuring that a greater volume of air is directed toward the fan blades, improving their rotational speed and, consequently, the overall energy generation efficiency of the device.

Positioned directly beneath the light barrel 10 is the wind guide plate 12, which features an inwardly concave wind guide arc surface 13. The wind guide arc surface 13 is critical in channeling airflow toward the power generation fan blades 7, optimizing the wind energy captured by the system.

In the illustrated embodiment, a crossbeam plate 14 is mounted within the light barrel 10, supporting a drive motor 15 and a spiral blade 16. The spiral blade 16 generates swirling airflow, accelerating the movement of air from the bottom to the top of the light barrel 10. This accelerated airflow converges with the surface wind directed by the wind guide plate 12, ensuring the efficient operation of the power generation fan blades 7.

In the illustrated embodiment, a plurality of wind direction monitors 11 are evenly distributed along the top cover 9. The wind direction monitors 11 are arranged equidistantly and disposed between the top cover and the interface platform. The monitors 11 are configured to provide real-time data to a controller 20 housed within the outer cover 2. The controller 20 is adapted to communicate with drive motors 3 connected to drive rods 4, enabling the rotation of turntables 5 and the adjustment of the power generation fan blades 7 to align with the detected wind direction. In the illustrated embodiment, the wind direction monitors are CWU 200 models and the controller is DR610-DR620.

In the illustrated embodiment, air vents 19 are disposed along the wind guide plate 12, allowing surface wind to enter the device and enhancing the airflow dynamics. The wind direction monitors 11, positioned equidistantly on the top cover 9, detect changes in wind direction and communicate with the controller 20 within the outer cover 2.

A battery 21 is disposed inside the outer cover 2 and between the driving motor 3 and the controller 20. The battery 21 is responsible for storing the electricity generated by the system for later use or transmission to an external power grid. Positioned within the outer cover 2, the battery is safeguarded against environmental factors, ensuring long-term reliability and durability. It serves as an energy reservoir, allowing the device to provide a consistent power supply even when immediate consumption or grid connection is unavailable. The battery works in conjunction with the controller 20, which monitors energy output and storage levels, ensuring efficient management of the generated electricity. By incorporating a battery, the device is able to bridge periods of fluctuating power generation, such as during low wind or sunlight conditions, thereby ensuring a steady and uninterrupted energy supply. The battery can be designed using advanced energy storage technologies such as lithium-ion or other high-capacity, durable materials, providing scalability and adaptability for various operational needs.

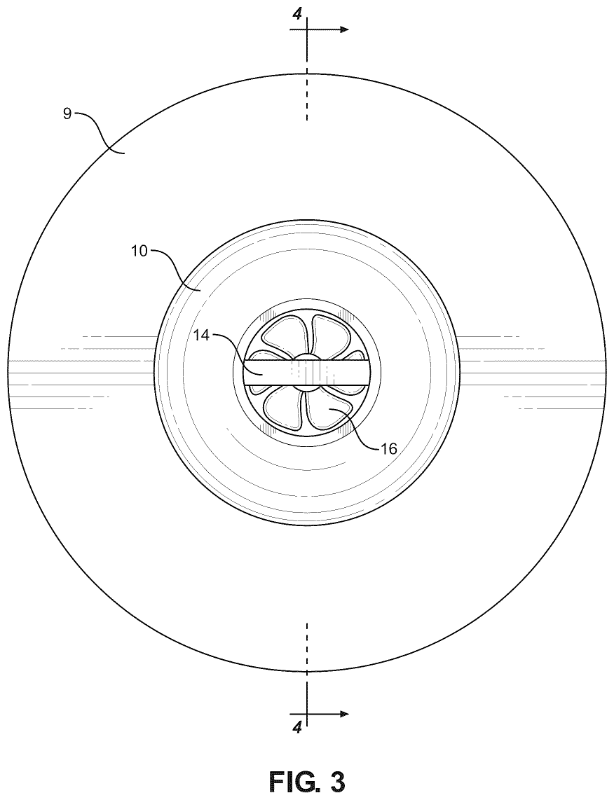

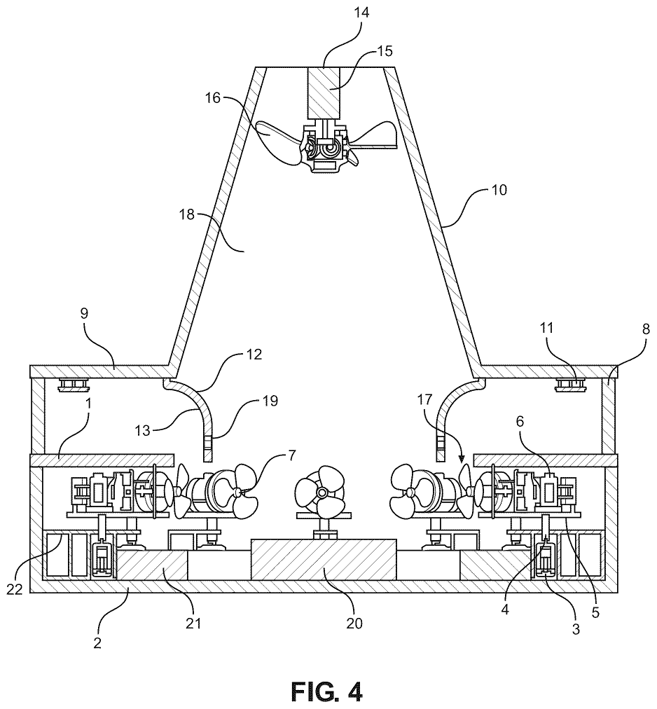

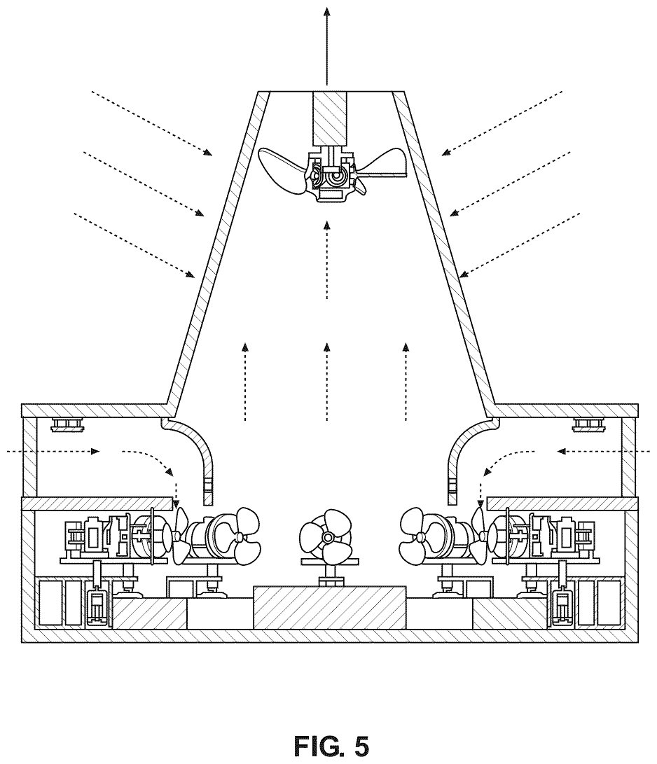

Referring now to FIGS. 4 and 5, there is shown a cross-sectional view of an embodiment of a wind power generation device taken along line A-A of FIG. 3 and a cross-sectional view illustrating the air flow direction of an embodiment of a wind power generation device, respectively. In the illustrated embodiment frame 22 serves as the stabilizing structure of the wind power generation device, providing foundational support and ensuring the secure placement of internal components within the outer cover 2. Positioned centrally within the device, the frame 22 accommodates the generator sets 6, drive motors 3, and drive rods 4, ensuring these components remain securely aligned during operation. The frame is constructed from high-strength materials, such as reinforced steel or aluminum alloys, to withstand mechanical stresses and environmental conditions. Additionally, the frame supports the rotational mechanism of the turntables 5, enabling smooth and precise alignment of the power generation fan blades 7 with changing wind directions. The robust design of the frame contributes to the overall durability and operational efficiency of the device, ensuring long-term reliability and stability under continuous use. Its modular construction allows for easy assembly, maintenance, and scalability, making it a key component of the system's structural and functional integrity.

The wind power generation device operates by combining sunlight heating, surface wind convergence, and airflow control mechanisms to generate electricity efficiently under various environmental conditions. The device is installed with the outer cover buried below the interface platform, housing the generator sets and power generation fan blades. The top cover is positioned above the interface platform, supported by evenly spaced fixing columns. Upon activation, the controller located within the outer cover initializes the system and establishes communication with the wind direction monitors mounted on the top cover. These monitors continuously detect the wind direction and send real-time data to the controller.

Sunlight is absorbed by the light barrel, which is made of heat-absorbing material, creating a low-pressure zone within the barrel. This induces upward airflow as the heated air rises, pulling air into the system from the surrounding environment outside the device as well as from within the outer cover 2 through the air vents 19 and the first through hole 17. Concurrently, surface wind is directed by the wind guide plate, which features an inwardly concave wind guide arc surface. The wind guide plate channels airflow through the first through hole 17 located at the base of the top cover, concentrating the air directly onto the power generation fan blades. A spiral blade positioned within the light barrel, driven by a motor mounted on a crossbeam plate, generates swirling airflow within the barrel. This swirling airflow accelerates the movement of air from the bottom to the top of the light barrel and enhances the rotation of the power generation fan blades.

The wind direction monitors provide data to the controller, which adjusts the orientation of the fan blades to align with the incoming wind. The controller activates drive motors that rotate turntables via drive rods, ensuring that the fan blades are always optimally aligned with the wind direction. As the fan blades rotate, they drive the generator sets located within the outer cover, producing electricity that is either stored in a battery or transmitted to an external power grid. The airflow is further supplemented by additional vents positioned around the periphery of the device, which allow external air to enter and enhance the airflow directed toward the fan blades.

During periods of low wind, the low-pressure zone created by the light barrel ensures continuous airflow, maintaining the rotation of the fan blades and enabling the device to generate electricity efficiently even when wind speeds are minimal or inconsistent. At night or during periods without sunlight, the circumferential arrangement of the generator sets and fan blades allows the system to harness natural surface wind from multiple directions, ensuring consistent energy production. The controller continuously monitors system performance, making real-time adjustments to optimize energy output, while periodic maintenance ensures long-term operational efficiency. By leveraging solar heating, surface wind convergence, and precise airflow control, the wind power generation device provides an innovative and sustainable solution for efficient electricity generation.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A wind power generation device, comprising:
an outer cover seated on a first side of an interface platform, the outer cover housing a plurality of generator sets equidistantly and circumferentially distributed, each generator set coupled to power generation fan blades, wherein the outer cover includes a plurality of air vents configured to allow external air to enter;
a top cover connected to the interface platform via a plurality of fixing columns, the top cover including a light barrel, wherein the light barrel is composed of a heat-absorbing material and is configured to generate a low-pressure zone by inducing upward airflow as heated air rises within the light barrel;
a wind guide plate positioned between the light barrel and outer cover, the wind guide plate comprising an inwardly concave wind guide arc surface and at least one first through hole, wherein the wind guide plate is configured to direct surface wind from outside the device into the outer cover by channeling air along the wind guide arc surface and through the first through hole toward the power generation fan blades;
a rotational alignment system comprising a drive motor and a plurality of turntables, wherein each generator set is mounted on a corresponding turntable and is configured to rotate in response to a control signal to allow the power generation fan blades to align with the direction of incoming surface wind.

2. The wind power generation device of claim 1, further comprising a plurality of wind direction monitors mounted on the top cover, each wind direction monitor configured to detect changes in wind direction and transmit real-time data to a controller housed within the outer cover.

3. The wind power generation device of claim 2, further comprising a crossbeam plate mounted within the light barrel, the crossbeam plate supporting the drive motor connected to a spiral blade, wherein the spiral blade is configured to generate swirling airflow within the light barrel, accelerating the movement of air from the bottom to the top of the light barrel.

4. The wind power generation device of claim 3, further comprising a plurality of air vents positioned around the outer cover, the air vents facilitating the continuous inflow of external air, which is drawn into the system by the low-pressure zone generated by the light barrel and guided toward the power generation fan blades by the wind guide plate.

5. The wind power generation device of claim 4, further comprising a battery housed within the outer cover, the battery configured to store electrical energy generated by the generator sets for transmission to an external power grid.

6. The wind power generation device of claim 2, further comprising a controller and a battery positioned within the outer cover, the controller configured to adjust the rotation of the generator sets based on wind direction data from the wind direction monitors.

7. The wind power generation device of claim 1, wherein the wind guide plate includes horn-shaped edges designed to further direct surface wind into the power generation fan blades.

8. The wind power generation device of claim 1, wherein the top cover and the light barrel form an integrated structure with a conical shape, the diameter of the light barrel decreasing from a bottom to a top of the integrated structure to enhance airflow acceleration.

9. The wind power generation device of claim 1, wherein each turntable is configured to rotate 360 degrees.

10. The wind power generation device of claim 1, wherein the generator sets are configured to generate electricity using surface wind in low to no sunlight conditions.

11. The wind power generation device of claim 1, wherein the wind guide plate includes a plurality of equidistant air vents positioned circumferentially within the outer cover to facilitate the inflow of external air into the device.

12. The wind power generation device of claim 1, wherein the fixing columns connecting the top cover to the interface platform are arranged at uniform intervals and are composed of reinforced steel to provide structural stability.

13. The wind power generation device of claim 1, wherein the outer cover comprises a weather-resistant enclosure designed to protect the generator sets, a controller, and a battery from environmental exposure.

14. The wind power generation device of claim 3, wherein the spiral blade is mounted centrally within the light barrel and configured to rotate about a vertical axis to generate a swirling airflow for enhancing the speed and volume of air passing through the chamber.

15. The wind power generation device of claim 2, wherein the wind direction monitors are mounted equidistantly on the top cover and communicate with a controller to enable real-time alignment of the power generation fan blades with surface wind direction.
